(19) United States
(12) Patent Application Publication
(10) Pub. No.: US 2011/0233392 A1
(43) Pub. Date: Sep. 29, 2011

(54) METHOD AND SYSTEM FOR USING LIGHT PULSED SEQUENCES TO CALIBRATE AN ENCODER

(75) Inventor: Philip A. Amante, Poquoson, VA (US)

(73) Assignee: MEASUREMENT SPECIALTIES, INC., Hampton, VA (US)

(21) Appl. No.: 13/019,774

(22) Filed: Feb. 2, 2011

Related U.S. Application Data
(60) Provisional application No. 61/318,098, filed on Mar. 26, 2010.

(51) Int. Cl. G01D 5/34

(52) U.S. Cl. 250/231.13

(57) ABSTRACT

An encoder to be mounted to a piston meter and configured to compute a volume of distributed fluid includes a light sensor configured to detect a light sequence and output signals indicative of the light sequence to a processing device, the processing device configured to determine if the light sequence is one of one or more authorized light sequences, wherein the processing device enters a calibration mode if the light sequence is one of the one or more authorized light sequences.

### CROSS-REFERENCE TO RELATED APPLICATIONS

This application claims priority under 35 U.S.C. §119(e) to Provisional Patent Application Ser. No. 61/318,098 entitled “Method and System for Using Light Pulsed Sequences to Calibrate An Encoder” filed Mar. 26, 2010, the subject matter thereof incorporated by reference in its entirety.

### FIELD OF THE INVENTION

The present invention relates generally to fluid distribution systems, and more particularly, to encoders for measuring the output of fluid distribution systems.

### BACKGROUND

Fluid distribution systems often implement encoders to measure quantities of dispensed fluid. Typical encoders mate to a portion of a fluid measuring device, such as the shaft of a piston meter, and operate to determine the amount of distributed fluid by measuring the number of shaft rotations. Due to mechanical instability in these systems, the volume measuring devices must be calibrated periodically to ensure an accurate correlation between the volume of dispensed fluid and the detected meter value. In the case of a piston meter, the calibration may include measuring the number of shaft rotations of the meter corresponding to a given volume output.

Many state laws require fuel distribution systems (e.g. consumer gasoline pumps) to be periodically calibrated. By way of example only, a fuel distribution system's measuring device may require annual calibration by an authorized inspector. To calibrate the dispenser, an inspector typically actuates mechanical switches within the dispenser or an attached encoder to enter a calibration mode. After calibration, an anti-tampering device, such as a lead wire seal, is passed through both the encoder and a plug covering the switch area to prevent unauthorized access to the mechanical switches utilized for calibration. The lead wire seal may be stamped on its exterior with a specific character sequence to show that the dispenser has been calibrated within the required time period. The presence of an intact lead wire seal having the authorized character sequence is evidence that an authorized inspector has calibrated the dispenser and that its calibration has not subsequently been tampered with.

However, due at least in part to the relative ease with which lead seal wires may be duplicated, encoder calibrations are frequently tampered with. In particular, an individual may insert their own new lead wire seals stamped with a character sequence identical to the character sequence from the authorized lead wire seal installed upon initial authorized calibration. Such tampering may slightly modify the calibration (e.g. altering the calibration by only a few percent). However, as the calibration may not be re-checked for a relatively long period of time, customers may be overcharged for substantial amounts of time before the problem is discovered and a state inspector properly recalibrates the pump.

Tamper-resistant encoder designs may be limited by the operating environment of a fuel distribution system. For example, encoders are typically located within the cabinet of a fuel distribution system designed to be highly ventilated to allow leaked or spilled fuel to evaporate efficiently. However, the presence of highly combustible fuel vapors around the encoder represents a substantial risk. For example, switches used in typical encoders to enter a calibration mode present a risk of an electrical arc igniting fuel vapors. Similarly, designs that employ mechanical mechanisms risk ignition of fuel vapors resulting from sparks caused by friction within the mechanisms. Encoders having mechanical switches present additional problems. For example, while these encoders may be designed to have an average lifespan of approximately 20 years, because the mechanical switches are only rarely used (e.g. only for yearly calibration), the switches may corrode and fail long before the rest of the encoder.

Accordingly, alternative tamper resistant encoders configured to operate in a highly combustible environment for extended periods of time are desired.

### SUMMARY

In one embodiment of the present invention, an encoder for a fluid dispensing system is provided. The encoder comprises a sensor configured to detect a light sequence and output signals indicative of the sensed light sequence. A controller responsive to the output signals is configured to place the encoder in a calibration mode if the output signals are indicative of a predetermined light sequence.

Another embodiment of the present invention includes a method of operating an encoder for a fluid dispensing device. The method comprises the steps of sensing a light sequence, comparing the sensed light sequence to a predetermined light sequence, and placing the encoder in a calibration mode if the sensed light sequence is the same as the predetermined light sequence. In any of the embodiments, the light sequence may be defined by a number of characteristics, alone or in combination, including a specific wavelength or spectrum of light, the presence of light in general, and/or a pulsed light sequence for authorizing entry into a calibration mode. By way of example only, entry into the calibration mode may be triggered by the continuous presence of light at a specified wavelength, or by the presence of light at a specified wavelength provided in a predetermined pulsed sequence.

### BRIEF DESCRIPTION OF THE DRAWINGS

FIG. 1 is a cross-sectional view of an encoder according to an embodiment of the present invention.

FIG. 2 is a cross-sectional view of an encoder according to an alternate embodiment of the present invention.

FIG. 3 is a detailed cross-sectional view of section CC of FIG. 1.

FIG. 4a is a side perspective view of an exemplary light pipe.

FIG. 4b is a cross-sectional view of the exemplary light pipe of FIG. 4a bisected along line A.

FIG. 4c is a bottom perspective view of the exemplary light pipe of FIG. 4a.

FIG. 4d is a side perspective view of the exemplary light pipe of FIG. 4a.

FIG. 4e is a side perspective view of the exemplary light pipe of FIG. 4a.

FIG. 5a is a side perspective view of an exemplary plug according to an embodiment of the present invention.

FIG. 5b is a cross-sectional view of the exemplary plug of FIG. 5a bisected along line A.

FIG. 5c is a bottom perspective view of the exemplary plug of FIG. 5a.

FIG. 6 is a process flow diagram showing the steps performed by components/devices embedded on a printed circuit board to calibrate an exemplary encoder.

FIG. 7 is a process flow diagram useful for describing the calibration of an exemplary encoder.

FIG. 8 is a diagram of an exemplary circuit embedded on a printed circuit board according to an embodiment of the present invention.

### DETAILED DESCRIPTION OF PREFERRED EMBODIMENTS

It is to be understood that the figures and descriptions of the present invention have been simplified to illustrate elements that are relevant for a clear understanding of the present invention, while eliminating, for purposes of clarity, many other elements found in typical fluid distribution systems. However, because such elements are well known in the art, and because they do not facilitate a better understanding of the present invention, a discussion of such elements is not provided herein. The disclosure herein is directed to all such variations and modifications known to those skilled in the art.

In the following detailed description, reference is made to the accompanying drawings that show, by way of illustration, specific embodiments in which the invention may be practiced. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout several views.

An embodiment of the present invention is directed to an encoder for a fluid dispenser configured to limit the performance of recalibration operations to authorized personnel only. Specifically, the encoder requires receipt and verification of a predetermined light-based signal or sequence (e.g. a pulsed sequence) for enabling the encoder to enter a calibration mode. The signal or sequence may be operative as a code according to any of a number of parameters, including but not limited to amplitude, frequency, wavelength, pulse duration, and/or combinations of the above.

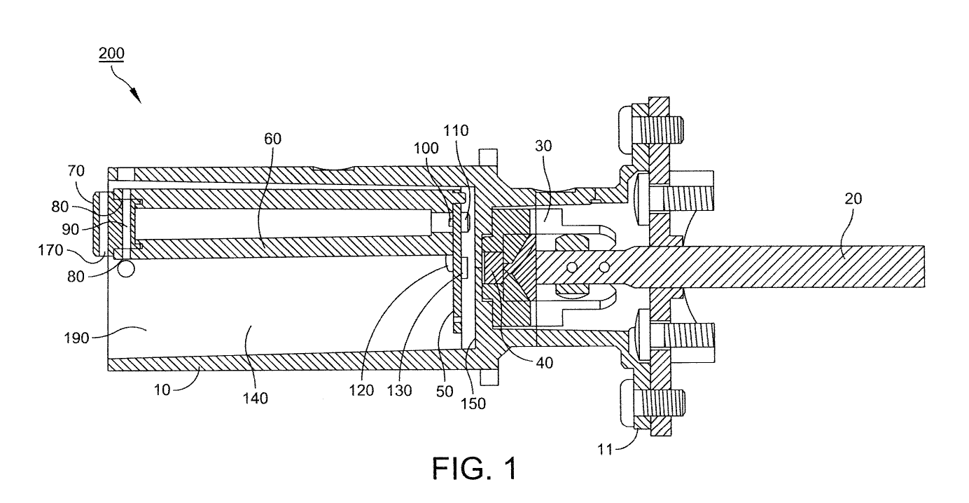

FIG. 1 is a cross-sectional view of an exemplary encoder 200 bisected along a central axis. The exemplary encoder 200 includes a housing 10 generally comprises an elongated cylinder having exterior projections 11 configured for mating with or mounting to a conventional piston meter (of which only the shaft 20 is shown). Housing 10 may comprise a rigid material, for example a metal such as aluminum, aluminum alloy or any other suitable material, and may be manufactured in conventional fashion, such as by forging, casting and/or machining.

The exemplary encoder 200 is configured to interface with, for example, a piston meter. By way of brief summary, encoder 200 may operate in the following fashion. The shaft 20 extending from the piston meter is affixed to a magnet 40 via a mounting structure 30. In this way, magnet 40 is configured to rotate at the same rate as (or at a predetermined rate relative to) shaft 20. A magnetic sensor 130 mounted to a printed circuit board (PCB) 50 may be positioned in proximity to magnet 40. Magnetic sensor 130 may be configured to substantially continuously sense the magnetic field created by the rotating magnet 40 and output to PCB 50 signals indicating the flux density and direction of the magnetic field. One or more processing components arranged on PCB 50 may perform steps to compute a volume of distributed fuel from the sensed changes in the magnetic field created by magnet 40. PCB 50 may be operatively coupled to a transmission line (e.g. an RS-485 line) to output signals indicative of the volume of distributed fuel to downstream components. While the forgoing describes the components and operation of exemplary encoder 200, the present invention relates generally to the calibration of encoders. Thus, the present invention is not limited to the embodiments of encoders described herein.

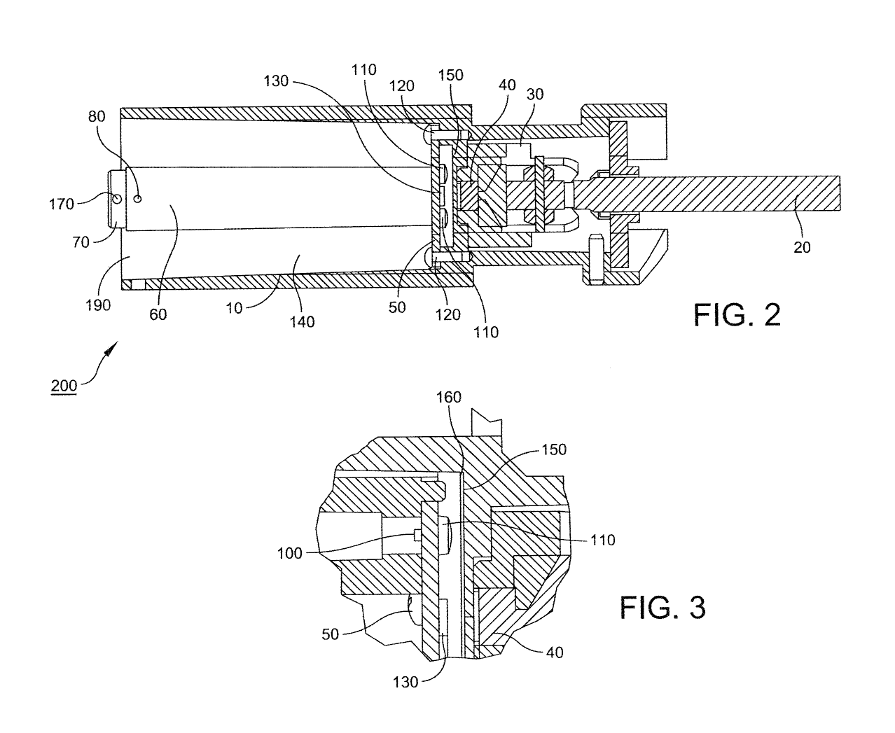

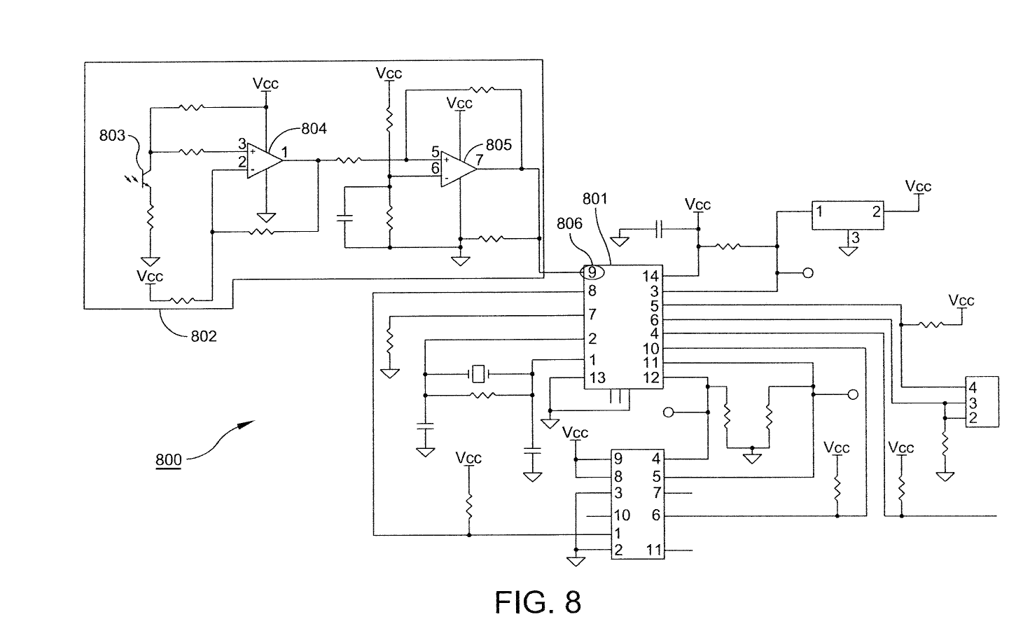

According to an embodiment of the present invention, PCB 50 is mounted within a PCB cavity 140. PCB cavity 140 comprises the interior of housing 10 spanning the distance from an end 190 distal to the piston meter, to casting wall 150. As shown in FIG. 1, PCB 50 may be mounted to a light pipe 60, which will be set forth in further detail below, and/or mounted to portions of housing 10 offset from the surface of casting wall 150, as shown in FIG. 2. Mounting PCB 50 in either embodiment provides a gap (e.g. about 3 mm gap) between the surface of PCB 50 facing casting wall 150 and casting wall 150. PCB 50 may be mounted via conventional mounting structures, such as one or more PCB mounting screws 120. Housing 10 may further include threaded bores configured to receive PCB mounting screws 120 in the embodiment of FIG. 2. A schematic diagram of an exemplary PCB 50 is described herein with reference to FIG. 8.

Encoder 200 may include a polyimide film 160 adhered to a surface of casting wall 150 facing PCB 50 as shown in FIG. 3. Polyimide film 160 may be required as a secondary layer of insulation to meet ATEX (Explosive Atmospheres) requirements. Polyimide film 160 may be adhered to the surface of casting wall 150 by a typical adhesive or adhesive sheet. Alternative embodiments of encoder 200 may omit polyimide film 160.

Referring generally to FIGS. 1-3, encoder 200 includes a light sensor 100 which may be embedded on a surface of PCB 50 facing the end 190 of PCB cavity 140. Light sensor 100 may be a typical light sensor configured to output signals indicative of sensed light to processing components/devices embedded on PCB 50. By way of non-limiting example, light sensor 100 may be a surface mount phototransistor.

Encoder 200 may also include light pipe 60 configured to direct light toward light sensor 100. Light pipe 60 may comprise a hollow cylinder extending from a surface of PCB 50 surrounding light sensor 100 toward the distal end 190 of the PCB cavity 140. Light pipe 60 may be mounted to PCB 50 in conventional fashion, such as by one or more mounting screws 110. Light pipe 60 may comprise a rigid material, for example a thermoplastic, and may be manufactured in any conventional fashion, such as, by way of non-limiting example, injection molding.

Due to the prevalence of fuel vapors in the operating environment of encoders, PCB cavity 140 may be potted sufficiently to completely seal PCB 50 within a potting material. By way of non-limiting example, about one quarter of PCB cavity 140 comprises potting material. The PCB cavity 140 potting material may be a typical potting material, such as epoxy, urethane, or silicone, for example. Such a material should be generally opaque (e.g. should not be light transmissive in the visible, UV, or IR range), and be applied to a depth sufficient to meet minimum coverage standards, such as the ATEX requirement of 3 mm of coverage above the highest component.

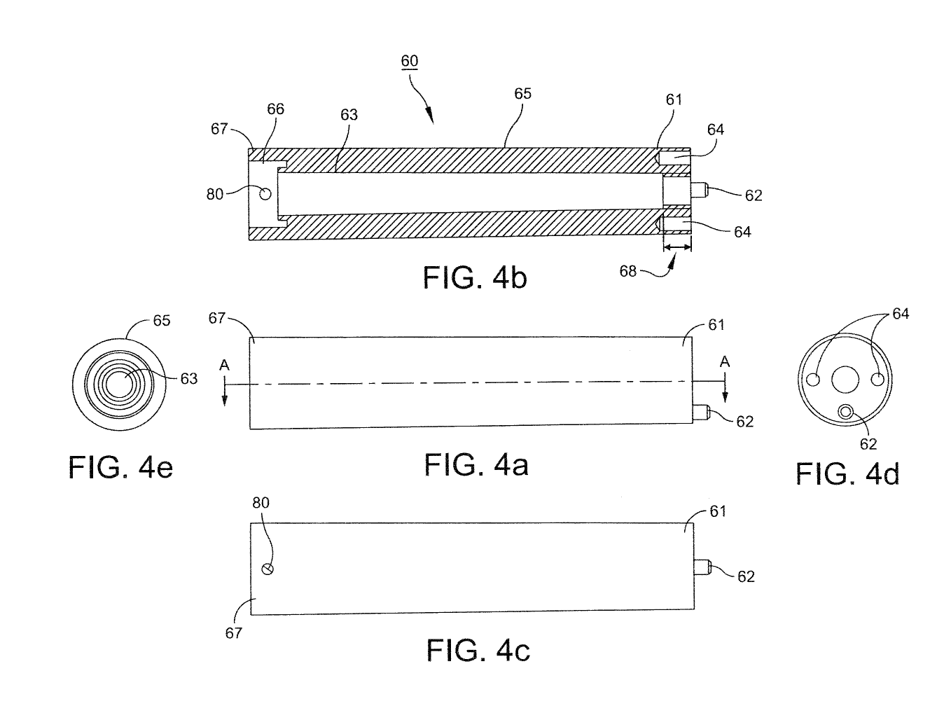

Referring to FIGS. 4a-4e, multiple views of light pipe 60 independent of encoder 200 are shown. A first end 61 of light pipe 60 may include one or more projections 62 configured to engage with one or more corresponding bores in PCB 50 (not shown). First end 61 of light pipe 60 may also include one or more threaded bores 64 configured to receive light pipe mounting screws 110 (FIGS. 1-3). Both the hollow center 63 and the exterior surface 65 of light pipe 60 may have a draft (e.g. a 0.5° draft) extending from first end 61 to a second end 67. Second end 67 of light pipe 60 may include a recess 66 configured to receive a plug 70 (plug 70 is shown engaged with light pipe 60 in FIGS. 1 and 2). The dimensions of recess 66 are generally complementary to plug 70. In an exemplary embodiment, recess 66 may have a diameter greater than the diameter of hollow center 63 of light pipe 60. Recess 66 may further include a draft (e.g. a 0.5° draft) and may include a chamfer (e.g. a 45° chamfer) formed on the second end 67 of light pipe 60. The draft and chamfer may assist with insertion of plug 70 into recess 66 and removal therefrom. It is also envisioned that a press or friction-fit may be provided between recess 66 and the outer surface of plug 70 for retaining a portion of plug 70 within the recess 66.

Light pipe 60 may additionally include a pipe wire bore 80. Pipe wire bore 80 is formed completely through light pipe 60. As may be seen in FIG. 1, pipe wire bore 80 is complementary to a plug wire bore 90 formed in plug 70. Complementary pipe wire bore 80 and plug wire bore 90 allow for insertion of a wire therethrough when plug 70 is inserted into recess 66 of light pipe 60, thus securing the plug 70 within the light pipe 60.

Upon installation of light pipe 60 into encoder 200 during assembly, hollow portion 63 of light pipe 60 may be partially potted. Potting protects light sensor 100 positioned at first end 61 of light pipe 60. Potting additionally reduces the risk of the interface between light sensor 100 and PCB 50 igniting highly combustible fuel vapors in the vicinity of the encoder. By way of non-limiting example, light pipe 60 may be potted to a minimum potting height 68 as shown in FIG. 4b. The insulating material used for potting light pipe 60 may be clear potting (i.e. potting configured to transmit light) configured to allow sufficient levels of light to reach light sensor 100. In the process of potting light pipe 60, potting may be allowed to weep through the interface between light pipe 60 and PCB 50. By potting in such fashion prior to the potting of PCB cavity 140 as describe above, the potting partially filling PCB cavity 140, which does not transmit light, is prevented from entering light pipe 60 and covering light sensor 100.

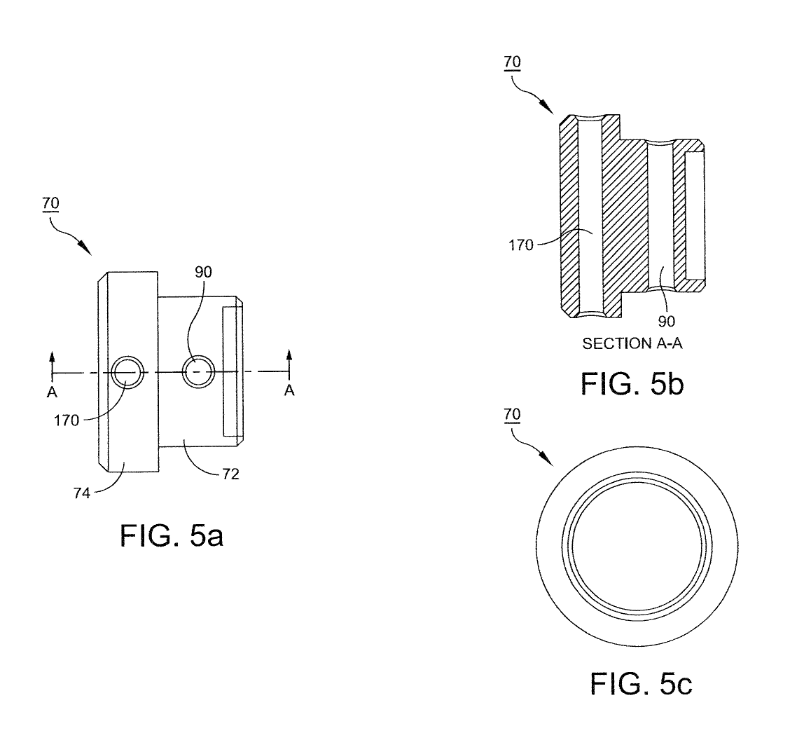

Referring to FIGS. 5a-5c, various views of plug 70 independent of encoder 200 are shown. Plug 70 may be configured to be removeably inserted into recess 66 of light pipe 60. As shown in FIG. 5a, plug 70 may include a first portion 72 configured to engage recess 66 of light pipe 60. Plug 70 may also include a second portion 74 having a greater cross-section diameter than that of first portion 72, thereby preventing second portion 74 from entering recess 66. Methods of securing plug 70 within recess 66 may include friction or press fits, as well as complimentary threads formed on both plug 70 and light pipe 60. Plug 70 includes plug wire bore 90 configured to allow a wire to pass completely through first portion 72. Plug 70 may also include a second bore 170 configured to allow a wire to pass completely through second portion 74. Plug 70 may comprise a rigid material, such as a thermoplastic, and may be manufactured in a conventional fashion, such as by injection molding.

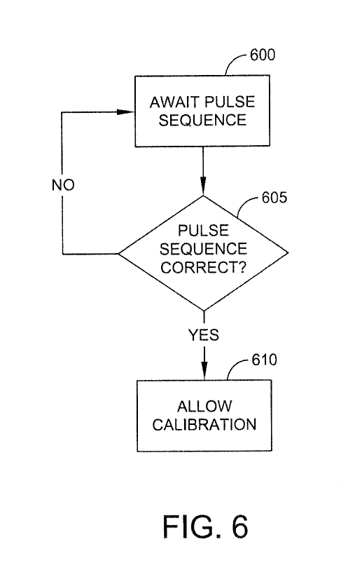

During regular operation of a fuel distribution system, encoder 200 operates in a traditional fashion as described above. However, the operation deviates from that of a typical encoder when one attempts to enter a calibration mode. FIG. 6 shows a process flow diagram of the steps performed by components and/or devices embedded on PCB 50 to calibrate encoder 200. This process will be described in view of the elements set forth above with respect to FIGS. 1-5c. At step 600, light sensor 100 awaits entry of a code. Awaiting entry involves substantially continuously monitoring for the presence of light (e.g. visible light), or the lack thereof, and outputting to PCB 50 signals indicative of sensed light. During ordinary operation of a fuel distribution system, plug 70 remains inserted into light pipe 60. Thus, light sensor 100 may output a signal indicating that there is no sensed light and thus to continue normal operation. Additionally, encoder 200 may be configured such that ambient light (i.e. light having a luminous intensity below a threshold value) is not sensed even when plug 70 is removed from light pipe 60.

To access the calibration mode, a specific light pattern is generated and detected. The light pattern may be defined by a number of characteristics including the presence of light in general, a specific wavelength or spectrum of light, and/or light provided in a predetermined pulsed sequence. By way of non-limiting example, entry into the calibration mode may be triggered by the continuous presence of light having a specified (or tightly controlled) wavelength. Alternatively, the light sequence may be defined by a combination of light characteristics. For example, light at a specified wavelength provided in a predetermined pulsed sequence may be used to trigger entry into the calibration mode. When sensor 100 detects a sequence of light over a threshold luminous intensity (e.g. 1-10 foot candles), sensor 100 outputs to PCB 50 a signal indicative of the received light sequence.

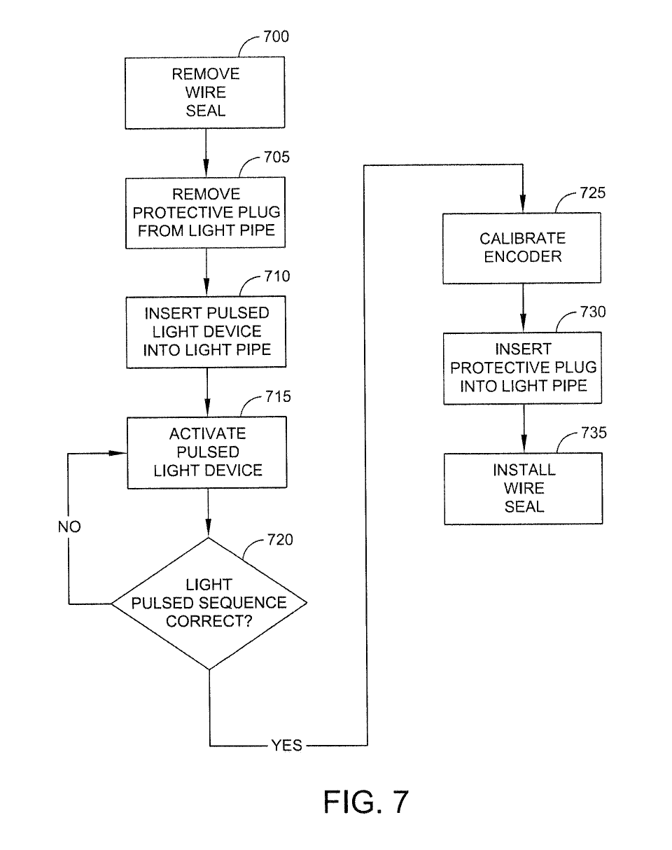

At step 605, one or more processing components embedded on PCB 50 determine if a light sequence comprises an “authorized code”. By way of non-limiting example, one or more “authorized code” sequences may be stored in memory embedded on PCB 50. Upon receipt of a light sequence, a processor or comparator may compare the received sequence with the one or more stored “authorized codes” to determine if there is a match. If the detected light sequence is not one of the authorized codes, the process flow may return to step 600. If the detected light sequence is determined to comprise an authorized code, the process flow may proceed to step 610 and allow calibration. In another embodiment, light sequences must be continuously provided to maintain the pump in calibration mode. At step 610, calibration of the encoder occurs, the steps of which will be described in detail with respect to FIG. 7.

FIG. 7 shows a process flow diagram for calibration of encoder 200 by a technician. In a normal operating state, a lead wire seal passes through both pipe wire bore 80 and plug wire bore 90 of encoder 200, thus preventing plug 70 from being removed from light pipe 60. At step 700, a technician removes the lead wire seal. A technician may, by way of example, cut the lead wire seal with a pair of wire snips. At step 705, the technician removes protective plug 70 from light pipe 60. Plug 70 may be press fit into light pipe 60 and thus removed by the technician applying a force in the direction of removal. The technician may, by way of example, grasp second portion 72 of plug 70 and manually, or with the aid of an instrument, extract plug 70 from light pipe 60. An another embodiment of the present invention, a second wire passing through second bore 170 in plug 70 may be pulled to remove plug 70 from light pipe 60.

At step 710, the technician generally aligns the light emitting portion of a light generating device with the open end of light pipe 60. In one embodiment, the light device may be configured to include a light emitting portion adapted to be received by recess 66. In alternate embodiments, the light device may be a simple light emitting device, such as a conventional flashlight. The device may be aimed by the technician so that at least a portion of its emitted light will enter the open end of light pipe 60.

At step 715, the technician activates the light device. In an embodiment utilizing a specifically-configured light device, the technician may press a button on the device which activates the pulsed sequence. In alternative embodiments utilizing a simple light emitting device, the technician may turn the light device on and off, manually generating a pulsed sequence.

At step 720, light sensor 100 embedded on PCB 50 provides signals indicative of the sensed light sequence to one or more processing components embedded on PCB 50. The processing components are operative to determine if the received light sequence is an authorized code. If the light sequence is an authorized code, encoder 200 enters a calibrate mode and the process flow proceeds to step 725. Alternatively, if the light sequence is not an authorized code, encoder 200 continues monitoring and the process flow returns to step 715. In an alternate embodiment, the processing components may signal, by way of a display on the dispenser, that the wrong code was entered.

At step 725, the pump may be calibrated. For example, a technician may dispense exactly 5 gallons into a calibrated prover can. If after dispensing 5 gallons and finding the dispenser is mis-calibrated the technician would, after entering the calibration mode using his light device in a manner described above, adjust the counts per 5 gallon increment (corresponding to the volume dispensed), by means of a keypad located on the pump and the display on the front of the dispenser to correct any mis-calibration. This would be done for each grade of fuel in that particular dispenser. Once the calibration is complete, the technician would close the program by, for example, removing the light device, or providing a second authorized code to end the calibration mode, and the pump would function normally. In addition to allowing calibration in step 725, encoder 200 may perform additional processes. By way of non-limiting example, encoder 200 may enter into a log which authorized code was entered and when the code was entered.

At step 730, the technician inserts protective plug 70 into recess 66 of light pipe 60 such that pipe wire bore 80 and plug wire bore 90 align. If pipe wire bore 80 and plug wire bore 90 do not align, the technician may rotate plug 70 until alignment is achieved. Once the bores align, the plug is fully installed and the process proceeds to step 735.

At step 735 the technician installs a new lead wire seal. The new lead wire seal may include a character sequence evidencing that it was installed by an authorized technician and thus that the encoder was last calibrated by an authorized technician.

FIG. 8 shows a circuit diagram of an exemplary circuit 800 which may be embedded on a printed circuit board according to an embodiment of the present invention, an operative to control the above-described functions of the present invention. Circuit 800 includes a microprocessor 801 configured to monitor the output of a calibration light sensor circuit 802. Specifically, a pin 806 (RC0) of microprocessor 801 may be operatively coupled to an output of calibration light sensor circuit 802.

Calibration light sensor circuit 802 may comprise a light sensor 803 configured to output a signal indicative of detected light to an amplifier 804. Amplifier 804 and associated circuitry are configured to amplify the signal output from light sensor 803 and to output the amplified signal to a comparator 805. Comparator 805 and associated circuitry are configured to change the output of the comparator 805 from a high voltage to a low voltage when comparator 805 receives the amplified signal from amplifier 804 signifying light has been detected.

Microprocessor 801 may substantially continuously monitor the output of calibration light sensor circuit 802 operatively coupled to pin 806. Microprocessor 801 detects the presence of light when the voltage received at pin 806 is in a low state and detects the absence of light when the voltage received at pin 806 is in a high state. Microprocessor 801 may cache data indicative of the timing of received light pulses and may compare the cached sequence to an authorized sequence. If the cached light sequence detected by microprocessor 801 is an authorized sequence, processor 801 may enter a calibration mode. Alternatively, if the cached light sequence is an unauthorized sequence, processor 801 may remain in a non-calibration mode. Microprocessor 801 may further output signals to downstream components in response to signals received on pin 806. By way of example, microprocessor 801 may send signals to downstream components via a transmission medium (e.g. an encrypted RS-485 line) operatively coupling downstream components to a first output port 807 and a second output port 808.

Alternative embodiments of the present invention may implement computer code stored on a computer readable medium, such as an optical drive or other memory by way of example only. The computer code configured to be executed performs the steps of analyzing signals indicating a pulsed light sequence detected by a light sensor, determining if the pulsed light sequence is an authorized code, outputting a signal to downstream components to enter a calibration mode if the pulsed light sequence is an authorized code, and awaiting signals indicating a new pulsed light sequence if the pulsed light sequence is not an authorized code.

In addition to preventing unauthorized users from recalibrating an encoder, embodiments of the present invention provide for an encoder with no mechanical switches. As discussed in the background, mechanical switches create a risk of igniting fuel vapors surrounding the encoder. Moreover, all circuitry in embodiments of the present invention may be potted to prevent the possibility of an arc igniting the fuel vapors. Embodiments of the present invention further eliminate moving mechanical parts required for calibration, thus reducing the risk of a frictional spark igniting fuel vapors and the risk of part failures.

While the forgoing generally describes sensing a pulsed light sequence of light having a luminous intensity above a threshold value, many different pulsed light sequences may be detected. The sequence may be as simple as providing a light having a luminous intensity within a predetermined range into the light pipe of the encoder. Alternative sequences may resemble Morse code and may permit an inspector to manually enter a light code with a flashlight. Still other alternative sequences may involve pulsed light sequences programmed into a light emitting device to transmit rapidly changing (e.g. on the order of milliseconds) light pulses. Further, while an embodiment of the present invention may provide that the light sensor detects only whether light above a threshold is detected or not, alternative embodiments may include several luminous intensity bands of detected light. In such embodiments, a light emitting device having controllable luminous intensity may be utilized to enter an authorized sequence.

Still further, embodiments of the present invention may implement light sensors configured to detect light outside of the visible range. By way of non-limiting example, an infrared light sensor may be embedded on the PCB and an inspector may provide an infrared light sequence to enter a calibration mode of the encoder.

The description of embodiments of the present invention generally relates to calibration of an encoder. The present invention also provides for a method of interacting/interfacing with an encoder for other maintenance or operation. By way of non-limiting example, an embodiment of the present invention may be configured to enter a programming mode in response to a sensed pulsed light sequence. For example, in a programming mode a technician may modify the pulsed light sequence required to access the calibration mode, the programming mode, or any other mode. This may advantageously allow a technician to modify the authorized pulsed light sequence if it becomes publicly known.

While the forgoing generally describes embodiments of the present invention implementing an encoder for use within a fuel distribution system, alternative embodiments of the present invention may provide a tamper resistant encoder designed to work in other highly combustible environments for extended periods. By way of non-limiting example, an alternative embodiment of the present invention may be implemented to measure rotations of shafts on oil rigs or in other ATEX environments. Further still, while the exemplary embodiments are described with respect to a piston meter used in dispensing fuel, other types of distribution and metering systems can be fitted with the above-described encoder without departing from the scope of the present invention. For example, the encoder of the present invention can be used on a gas or air metering system.

While the foregoing describes exemplary embodiments and implementations, it will be apparent to those skilled in the art that various modifications and variations can be made to the present invention without departing from the spirit and scope of the invention.

What is claimed is:

1. An encoder for a fluid dispensing system, the encoder comprising:
a sensor configured to detect a light sequence and output signals indicative of the sensed light sequence;
a controller responsive to the output signals and configured to compare the output signals to a predetermined light sequence and place the encoder in a calibration mode if the output signals are indicative of the predetermined light sequence.

2. The encoder of claim 1, further comprising a light pipe, the light pipe configured to allow the passage of light from a first end thereof to a second end.

3. The encoder of claim 2, further comprising a housing, wherein the sensor and the light pipe are arranged within the housing.

4. The encoder of claim 3, wherein the second end of the light pipe is oriented so as to direct light received at the first end to the sensor.

5. The encoder of claim 4, wherein the second end of the light pipe is arranged over the sensor.

6. The encoder of claim 5, wherein the controller and the sensor are arranged on a circuit board located within the housing.

7. The encoder of claim 6, wherein the light pipe is attached to the circuit board.

8. The encoder of claim 2, further comprising a plug configured to removably cover the first end of the light pipe.

9. The encoder of claim 8, wherein the plug and the light pipe comprise complementary bores configured to accept a wire lead.

10. The encoder of claim 1, wherein the controller comprises a comparator for comparing the detected light sequence to the predetermined light sequence.

11. The encoder of claim 1, wherein the calibration mode is operative to allow correlation of a known volume of dispensed fluid with a volume of dispensed fluid calculated by the encoder.

12. The encoder of claim 1, wherein the predetermined light sequence is defined by at least one of the presence of light, the wavelength of the light, the intensity of the light, and the spectrum of the light.

13. The encoder of claim 12, wherein the predetermined light sequence is further defined by a sequence of light pulses.

14. A method of operating an encoder for a fluid dispensing device, the method comprising the steps of:
sensing a light sequence;
comparing the sensed light sequence to a predetermined light sequence;
placing the encoder in a calibration mode if the sensed light sequence is determined to be the same as the predetermined light sequence.

15. The method of claim 14, further comprising the step of exiting the calibration mode if a second sensed light sequence is determined to be the same as a second predetermined light sequence.

16. The method of claim 14, further comprising the step of exiting the calibration mode upon termination of the sensed light sequence.

17. The method of claim 14, wherein the predetermined light sequence is defined by at least one of the presence of light, the wavelength of the light, the intensity of the light, and the spectrum of the light.

18. The method of claim 17, wherein the predetermined light sequence is further defined by a sequence of light pulses.

19. The method of claim 14, wherein the step of sensing the light sequence comprises exposing a light sensor to a light emitting source.

20. The method of claim 19, wherein the step of exposing the light sensor to a light emitting source comprises exposing an open end of a light pipe to the light emitting source, the light pipe to configured to provide the light sequence to the light sensor.
